(19) United States
(12) Patent Application Publication
(10) Pub. No.: US 2022/0180671 A1
(43) Pub. Date: Jun. 9, 2022

(54) METHODS AND SYSTEMS FOR ENGINE DIAGNOSTICS FOR VEHICLES USING OBD PORT

(71) Applicant: SANDEEP AGGARWAL, GURGAON (IN)

(72) Inventor: SANDEEP AGGARWAL, GURGAON (IN)

(21) Appl. No.: 17/509,069

(22) Filed: Oct. 25, 2021

Related U.S. Application Data
(63) Continuation-in-part of application No. 17/060,017, filed on Sep. 30, 2020, now abandoned.
(60) Provisional application No. 62/907,722, filed on Sep. 30, 2019.

(51) Int. Cl. G07C 5/00; G07C 5/08; H04W 4/80; H04L 12/40

(52) U.S. Cl. CPC G07C 5/008; G07C 5/0808; G07C 5/085; H04L 2012/40273; H04L 12/40; H04L 2012/40215; H04W 4/80

(57) ABSTRACT

A method for implementing an engine diagnostics for a vehicle using On-board diagnostics (OBD) port of the vehicle comprising: with an OBD device, obtaining a vehicle data of the vehicle and communicating the vehicle data to a smart device; with the smart device, recording the vehicle data of the vehicle and electronically sending the vehicle data a cloud-base vehicle analytics server system; capturing a GPS information of the OBD device; and wherein the vehicle data is recorded for three different modes, each recording data for different duration.

### CLAIM OF PRIORITY

This application claim priority to and is a continuation in party of U.S. patent application Ser. No. 17/060,017, filed on Sep. 30, 2020, and titled METHODS AND SYSTEMS FOR ENGINE DIAGNOSTICS FOR VEHICLES USING OBD PORT. United States Patent Application No. claims priority to U.S. Provisional Patent Application No. 62/907,722, filed on Sep. 30, 2019, and titled METHODS AND SYSTEMS FOR ENGINE DIAGNOSTICS FOR VEHICLES USING OBD PORT. These applications are hereby incorporate by reference in their entirety.

### BACKGROUND

Generally, when someone wishes to purchase a used vehicle (e.g. an automobile, etc.), the user can seek the lowest price. Additionally, when selling a used vehicle, the user can seek the highest price possible. It is also a common scenario that when someone is buying a used automobile from an individual seller, the buyer can acquire the used vehicle at a much lower price than buying from an automobile dealer considering the profit margin of the dealer in the transitional transaction. Similarly, when a user is selling a used vehicle, the used vehicle can fetch a better value when the sale is made to an individual buyer than an automobile dealer as the automobile dealer would try and acquire the vehicle at a lower price and add his/her profit margin during the transitional sale. However, individual users may not have the information to maximize their quoted prices to offer their used vehicle at. Additionally, a buying non-professional user may not have sufficient information to determine a reasonable price to purchase a used vehicle.

### SUMMARY OF THE INVENTION

A method for implementing an engine diagnostics for a vehicle using On-board diagnostics (OBD) port of the vehicle comprising: with an OBD device, obtaining a vehicle data of the vehicle and communicating the vehicle data to a smart device; with the smart device, recording the vehicle data of the vehicle and electronically sending the vehicle data a cloud-base vehicle analytics server system; capturing a GPS information of the OBD device; and wherein the vehicle data is recorded for three different modes, each recording data for different duration.

### BRIEF DESCRIPTION OF THE DRAWINGS

FIG. 1 illustrates an example process for implementing an engine diagnostics for vehicles using OBD port, according to some embodiments.

FIG. 2 illustrates an additional schematic view of a system for diagnostics for vehicles using smart-device/OBD device, according to some embodiments.

FIG. 3 illustrates another example process for an engine diagnostics for vehicles using OBD port, according to some embodiments.

FIG. 4 illustrates yet another example process for an engine diagnostics for vehicles using OBD port, according to some embodiments.

FIG. 5 illustrates an example process for obtaining vehicle data using a smart device/OBD, according to some embodiments.

FIG. 6 illustrates an example table with OBD-II diagnostic services, according to some embodiments.

FIG. 7 is a block diagram of a sample computing environment that can be utilized to implement various embodiments.

FIG. 8 illustrates an example OBD System Layout, according to some embodiments.

The Figures described above are a representative set and are not an exhaustive with respect to embodying the invention.

### DESCRIPTION

Disclosed are a system, method, and article of manufacture for an engine diagnostics for vehicles using OBD port. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment;’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment;’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Controller Area Network (CAN bus) is a robust vehicle bus standard designed to allow microcontrollers and devices to communicate with each other in applications without a host computer. It is a message-based protocol, designed originally for multiplex electrical wiring within automobiles to save on copper, but can also be used in many other contexts.

Diagnostic Trouble Code (DTC), in the automotive industry, codes that are prescribed by SAE standards to help track problems in a vehicle detected by its on-board computer.

Engine control unit (ECU) is a type of electronic control unit that controls a series of actuators on an internal combustion engine to ensure optimal engine performance.

Global Positioning System (GPS) is a satellite-based radio navigation system.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

On-board diagnostics (OBD) is an automotive term referring to a vehicle's self-diagnostic and reporting capability. OBD systems provide the vehicle owner or repair technician access to the status of the various vehicle subsystems.

Weighted average is the average of values which are scaled by importance. The weighted average of values is the sum of weights times values divided by the sum of the weights.

EXAMPLE METHODS AND SYSTEMS

In some embodiments, OBD refers to a vehicle's self-diagnostic and reporting capability. OBD systems give the vehicle owner or a repair technician access to state of health information for various vehicle sub-systems. An OBD II port can utilize five signaling protocols that are permitted with the OBD-II interface. Various vehicles may implement only one signaling protocol. It is often possible to deduce the protocol, based on which pins are present on the J1962 connector. OBD-II standard specifies the type of diagnostic connector and its pinout, the electrical signaling protocols available, and the messaging format. It also provides a candidate list of vehicle parameters to monitor along with how to encode the data for each. There is a pin in the connector that provides power for the scan tool from the vehicle battery, which eliminates the need to connect a scan tool to a power source separately. Example protocols include, inter alia: SAE J1850 PWM; SAE J1850 VPW; ISO 9141-2; ISO 14230 KWP2000; ISO 15765 CAN.

Furthermore, Modern OBD implementations use a standardized digital communications port to provide real-time data in addition to a standardized series of diagnostic trouble codes, or DTCs, which allow one to rapidly identify and remedy malfunctions within the vehicle.

The OBD-II standard specifies the type of diagnostic connector and its pin-out, the electrical signaling protocols available, and the messaging format. It also provides a candidate list of vehicle parameters to monitor along with how to encode the data for each. Monitored data include speed, rpm, ignition voltage, coolant temperature and oxygen sensor data, etc.

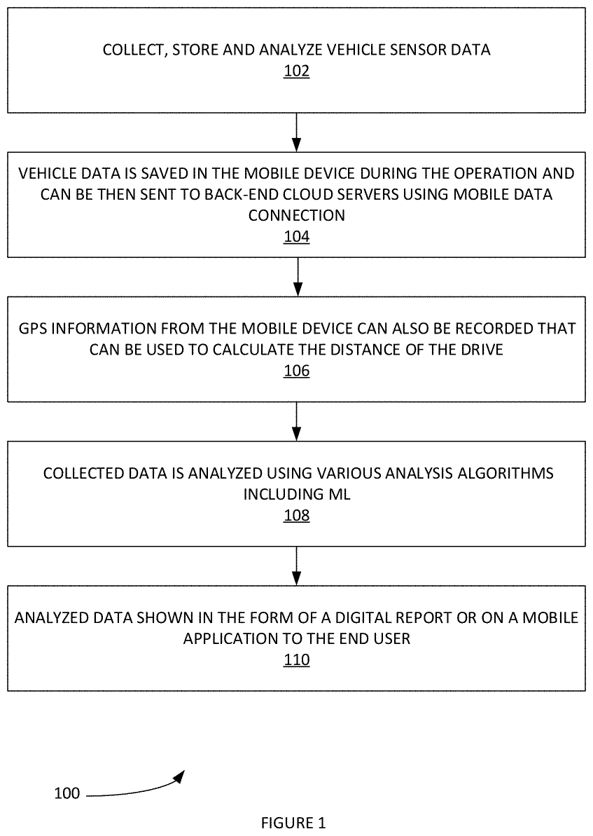

FIG. 1 illustrates an example process 100 for implementing an engine diagnostics for vehicles using OBD port, according to some embodiments. The OBD can use an OBD II protocol and be an OBD II device. Process 100 can use a cloud-based system. The cloud-base system can collect, store, and analyze vehicle sensor data in step 102. This can be done for a short period of time. This Data can be collected from OBD-2 port in the vehicle using a bluetooth based OBD device and/or a Mobile device. In step 104, the vehicle data can be saved in the mobile device during the operation and can be then sent to back-end cloud servers using mobile data connection. In step 106, the GPS information from the mobile device can also be recorded that can be used to calculate the distance of the drive at the back-end.

In step 108, the collected data thus collected is analyzed using various analysis algorithms including ML (e.g. see supra). This analyzed data can then be shown in the form of a digital report or on a mobile application to the end user in step 110. The analyzed data can have information about emission checks, insights to save fuel, engine load, preventive maintenance, and other vehicle parameters such as power, torque, fuel economy, battery voltage, and DTC information. It is noted that the analyzed data from an OBD-II can have value for insurance companies in deciding premiums, banks and NBFCs in valuing a vehicle, used vehicle buyers and sellers in better decision making, vehicle aggregators and fleet owners can be able to track and trace their assets along with continuous insights on preventive maintenance.

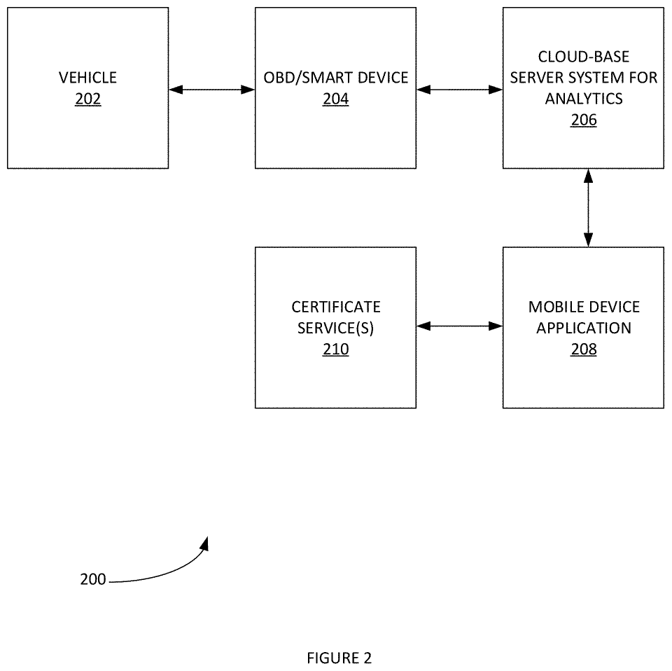

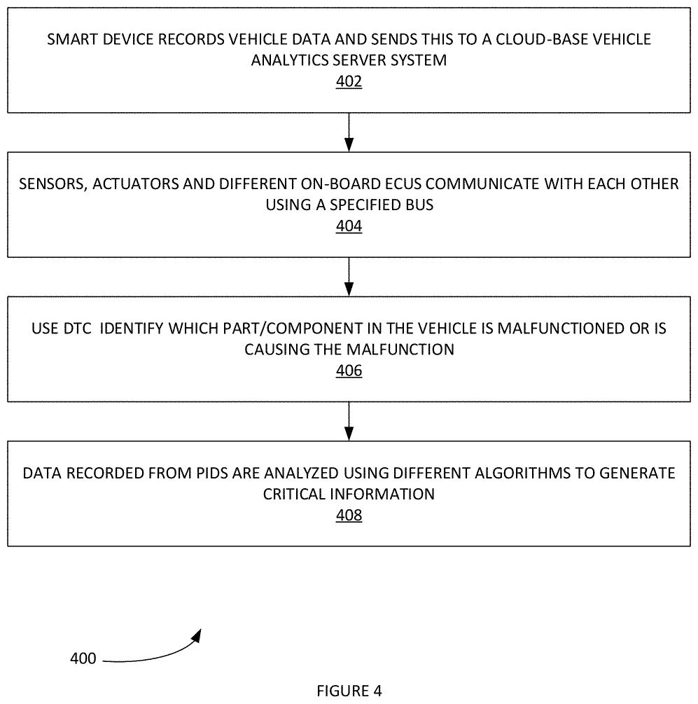

FIG. 2 illustrates an additional schematic view of a system 200 for diagnostics for vehicles using smart-device/OBD device, according to some embodiments. An OBD/smart device 204 can be used to extract data from vehicle 202. Example data extractions are discussed infra in the description of FIG. 4. This data is passed to cloud-base server system for analytics 206. Cloud-base server system for analytics 206 tracks, processes and analyzes the vehicle data. This data is then formatted for communication and viewing on a user-side mobile application 208. Additionally, this data can be used for various certification service(s) 210.

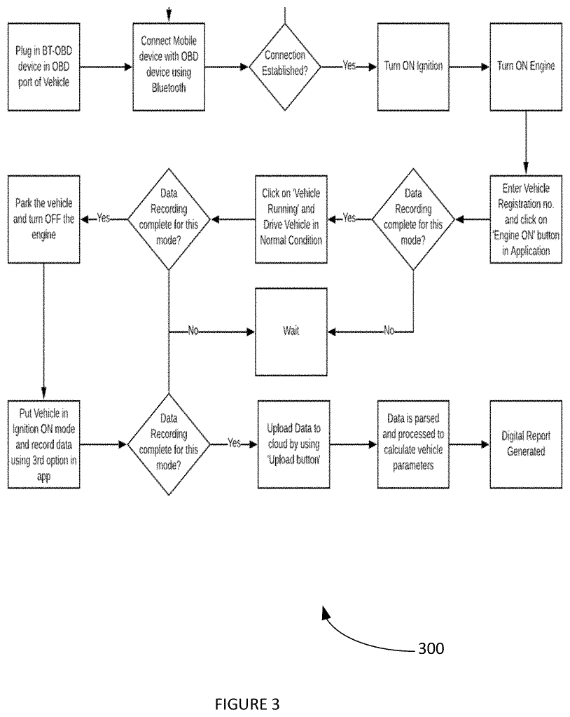

FIG. 3 illustrates another example process 300 for an engine diagnostics for vehicles using OBD port, according to some embodiments.

FIG. 4 illustrates yet another example process 400 for an engine diagnostics for vehicles using OBD port, according to some embodiments. In step 402, a smart device (e.g. a mobile device with a vehicle analytics application) records vehicle data and sends this to a cloud-base vehicle analytics server system. In one example, this can be an ANDROID™ and/or iPhone™ application. The mobile-device application can be capable of interacting with the Bluetooth® (and/other local wi-fi network protocol) OBD device and capture the device GPS information. The mobile-device application is installed in the mobile device used for the data capturing.

The data is recorded for three different modes, each recording data for different duration. The different modes are—Engine ON, Vehicle Running and IG ON. Each of these mode data is analyzed differently to obtain some suitable value.

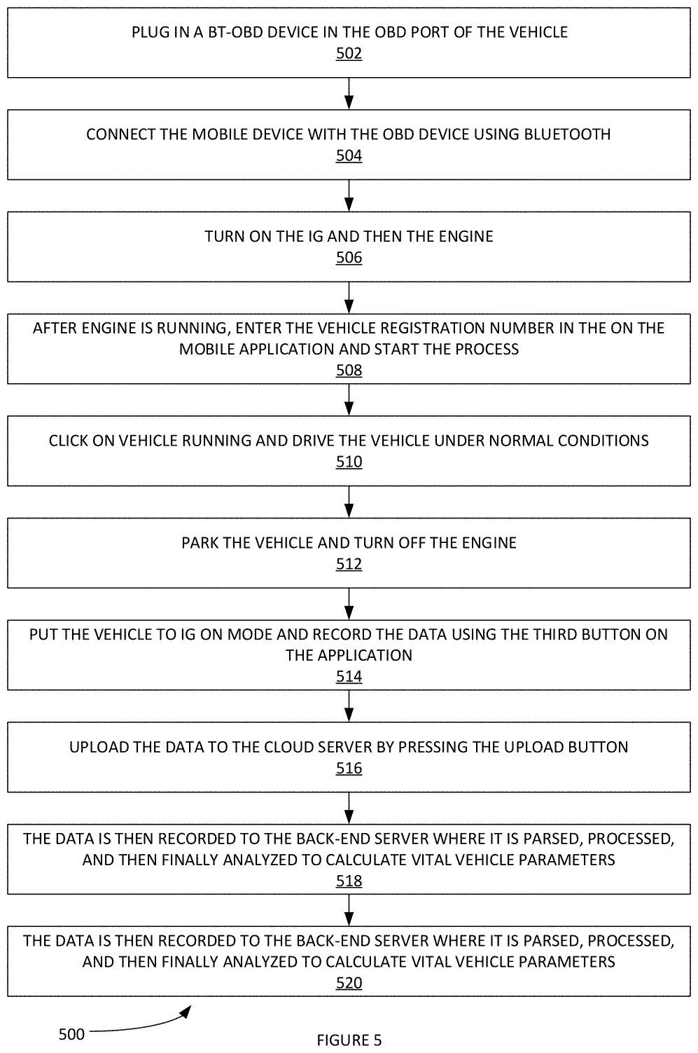

FIG. 5 illustrates an example process 500 for obtaining vehicle data using a smart device/OBD, according to some embodiments. Process 500 can be used to improve how vehicle data is recorded. In step 502, process 500 can plug in a BT-OBD device in the OBD port (also called Data Link Connector) of the vehicle. In step 504, process 500 can connect the mobile device with the OBD device using Bluetooth. In step 506, once the connection is established, Turn ON the IG and then the engine. In step 508, after engine is running, enter the vehicle registration number in the on the mobile application and start the process by clicking the engine ON button. In step 510, once the data recording is complete for this mode, click on Vehicle Running and drive the vehicle under normal conditions.

In step 512, once the data recording is complete for this mode, park the vehicle and turn OFF the engine. In step 514, process 500 can put the vehicle to IG ON (ignition on) mode and record the data using the third button on the application. In step 516, when the data recording modes are complete, upload the data to the cloud server by pressing the upload button. In step 518, the data is then recorded to the back-end server where it is parsed, processed, and then finally analyzed to calculate vital vehicle parameters like, inter alia: power, torque, fuel economy, DTC, etc. In step 520, this information is used to generate the digital report or is directly displayed on mobile device of end user.

Returning to process 400, in step 404, the Sensors, Actuators and different on-board ECUs communicate with each other using a specified bus (e.g. CAN bus). The CAN bus also enables the flow of data between different control modules. This can eliminate the need to install same kind of sensors in multiple locations. The OBD data in any vehicle also flows over the CAN bus.

It is noted that the CAN protocol defines how the data can flow over the network, but it does not control how to decode the raw data or to handle data longer than 8 bytes. Therefore, set of standardized protocols exists to further specify how data is communicated between ECUs of a given network. OBD2 is kind a language while the CAN bus is just the medium of communication. OBD2 is globally adopted protocol which is incorporated in each and every vehicle being sold now.

SAE has standardized the OBD protocols, parameter IDs (also known as PID) and the services used to access these PIDs on the Vehicle CAN network. These PIDs are used to obtain human readable live OBD data from a vehicle like the speed, RPM, throttle position, and DTCs, etc. In one example, there exists 10 diagnostic services under OBD-II specification, each of which is used to get different kind of data from the vehicle. Process 400 can use the Services $01, $03, $07, $09 and $0A to capture the relevant data.

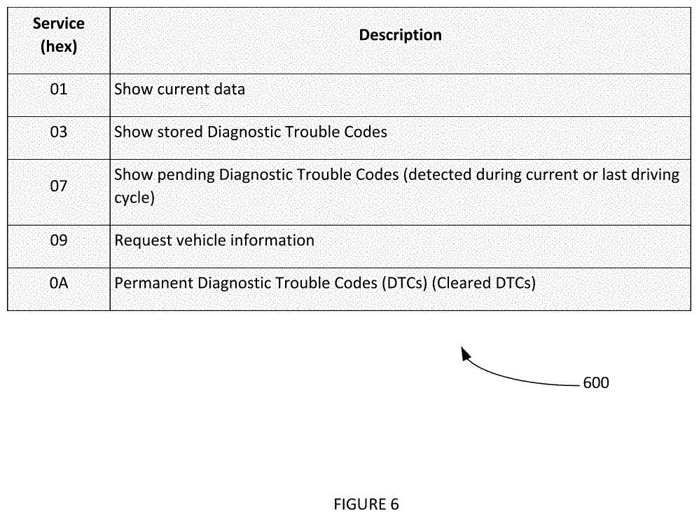

FIG. 6 illustrates an example table with OBD-II diagnostic services, according to some embodiments. Service $03, $07 and $0A are only used to capture different kinds of DTCs that may or may not light up the Malfunction Indicator lamp (MIL) (also called as engine light) on the cluster meter of the vehicle. These DTC are in the form of five-character alpha-numeric code each of which is linked to a particular malfunction. In step 406, process 400 uses DTC identify which part/component in the vehicle is malfunctioned or is causing the malfunction. This data also enable us to categorize the severity of malfunction in the vehicle.

Service $01 and $09 have sub services which can be accessed by using the PID. Each of these PID correspond to a particular real-time data of the vehicle and has a different encoding to convert it from the raw to meaningful data. It is not necessary for any vehicle to support the PIDs. Supported PID in any vehicle depends on the availability of particular sensor or actuator. However, some basic PIDs needs to be supported by the vehicles.

In step 408, the data recorded from PIDs are analyzed using different algorithms to generate critical information. This information includes, inter alia: Power, Torque, Fuel Economy and Battery Health, etc. of the vehicle.

The data PID of Service $09 is used to ensure that the Engine Controller being used in the vehicle is not tempered with and belongs to that particular vehicle, according to some embodiments. PID from this service gives data such as Vehicle Identification Number (VIN), Calibration ID, ECU Name, etc.

By recording data from the OBD and analyzing it using complex algorithms, a concept of vehicle health evaluation called as ECO: Engine Diagnostic Report can be implemented. This can be used to rate any on road four-wheeler using this concept. This report can be exclusive for a particular vehicle and can be used by any individual/organization to judge the condition of any used vehicle, therefore helping in selling/purchasing them.

### Additional Example Computer Architecture and Systems

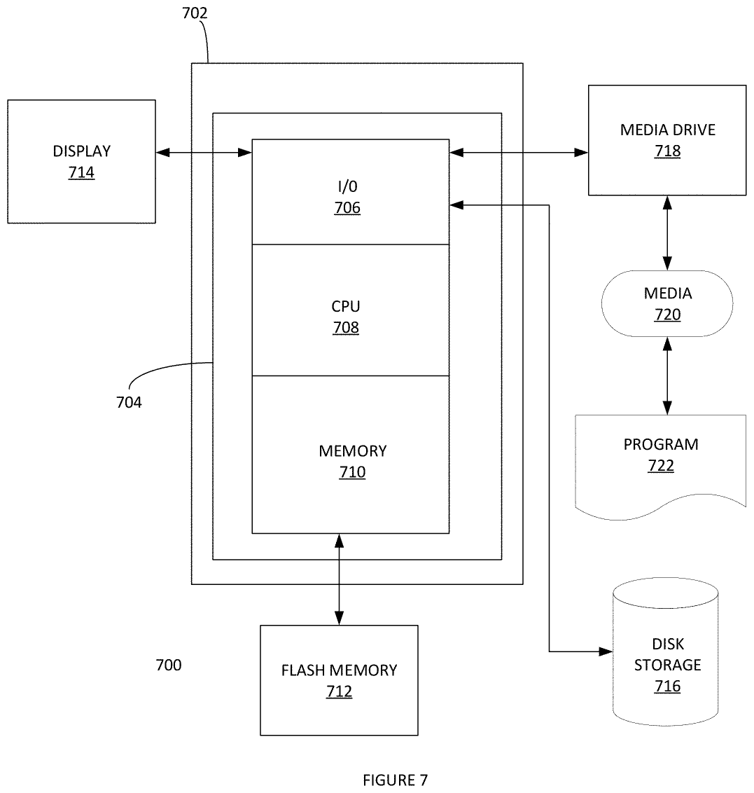

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

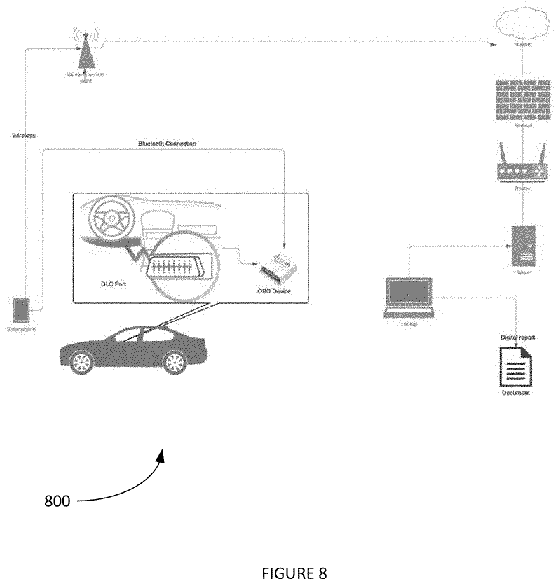

FIG. 8 illustrates an example OBD System Layout 800, according to some embodiments. The systems of FIGS. 7 and 8 can be used to implement the processes provided supra.

### Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, which is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for implementing an engine diagnostics for a vehicle using On-board diagnostics (OBD) port of the vehicle comprising:
with an OBD device, obtaining a vehicle data of the vehicle and communicating the vehicle data to a smart device;
with the smart device, recording the vehicle data of the vehicle and electronically sending the vehicle data a cloud-base vehicle analytics server system;
capturing a GPS information of the OBD device; and
wherein the vehicle data is recorded for three different modes, each recording data for different duration.

2. The method of clam 1, wherein a first mode is a an engine ON mode,

3. The method of clam 2, wherein a second mode is a vehicle running mode, and

4. The method of clam 3, wherein a third mode is an IG ON mode;

5. The method of claim 4, wherein the smart device comprises a mobile device with a vehicle analytics application.

6. The method of claim 5, wherein each of the three different modes is analyzed differently to obtain a specified suitable value.

7. The method of clam 4 further comprising:
plugging in a BT-OBD device in the OBD port of the vehicle.

8. The method of clam 7 further comprising:
connecting the mobile device with the OBD device using Bluetooth.

9. The method of clam 7 further comprising:
once the connection is established, turning ON the IG and then turning o the engine.

10. The method of clam 9 further comprising:
after the engine is running, entering the vehicle registration number in the mobile application, and starting the process by clicking the engine ON button.

11. The method of clam 10 further comprising:
once the data recording is complete for this mode, clicking on a vehicle running button on the mobile application display and driving the vehicle under normal conditions.

12. The method of clam 11 further comprising:
once the data recording is complete for this mode, parking the vehicle and turning OFF the engine.

13. The method of clam 12 further comprising:
putting the vehicle to IG ON (ignition on) mode and recording the vehicle data using the third button on the mobile device application.

14. The method of clam 14 further comprising:
when the data recording modes are complete, uploading the vehicle data to the cloud server by pressing the upload button.

15. The method of clam 14 further comprising:
recording the vehicle data to the back-end server where it is parsed, processed, and then finally analyzed to calculate vital vehicle parameters.

16. The method of claim 15, wherein the vital vehicle parameters comprise a vehicle power parameter, a vehicle torque parameter, a vehicle fuel economy parameter, and a vehicle DTC parameter.

17. The method of clam 16 further comprising:
Using the vehicle information to generate a digital report and displaying the vehicle information on a mobile device of an end user.

18. The method of claim 17, wherein the sensors, actuators and different on-board ECUs of the vehicle communicate with each other using a CAN bus, wherein the CAN bus enables the flow of vehicle data between different control modules without the need to install another set of sensors in multiple locations.

19. The method of claim 18, wherein the OBD data in the vehicle also flows over the CAN bus.

20. The method of claim 19 further comprising:
using a DTC to identify which component in the vehicle is malfunctioning, and wherein the vehicle data recorded from PIDs are analyzed using different algorithms to generate critical information.
